(19) United States
(12) Patent Application Publication
(10) Pub. No.: US 2025/0338159 A1
(43) Pub. Date: Oct. 30, 2025

(54) ENHANCED DATA COLLECTION FOR A WIRELESS COMMUNICATIONS SYSTEM

(71) Applicant: Lenovo (United States) Inc., Morrisville, NC (US)

(72) Inventors: Vahid POURAHMADI, München (DE); Tapisha SONI, München (DE); Joachim LÖHR, Wiesbaden (DE)

(21) Appl. No.: 19/263,155

(22) Filed: Jul. 8, 2025

(51) Int. Cl. H04W 24/10; H04L 47/36

(52) U.S. Cl. CPC H04W 24/10; H04L 47/36

(57) ABSTRACT

Various aspects of the present disclosure relate to data collection procedures that reduce the number of samples reported to a network entity and/or logged by a user equipment (UE), without introducing degradation in performance and/or accuracy of a trained artificial intelligence/machine learning (AI/ML) model or a related monitoring scheme. For example, the UE may receive control information that indicates a reduced sample size mode of operation associated with data collection, determine whether to apply the reduced sample size mode of operation for a measured set of data, and incorporate the measured set of data into a reduced set of samples based on the determination.

### TECHNICAL FIELD

The present disclosure relates to wireless communications, and more specifically to enhanced data collection procedures.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that provide and/or support enhanced data collection procedures, such as data collection using reduced numbers of logged or reported data samples.

A UE for wireless communication is described. The UE may be configured to, capable of, or operable to perform one or more operations as described herein. For example, the UE may comprise at least one memory and at least one processor coupled with the at least one memory and configured to cause the UE to receive, from a network entity, control information indicating a reduced sample size mode of operation associated with data collection performed by the UE, determine whether to apply the reduced sample size mode of operation for a measured set of data, and incorporate the measured set of data into a reduced set of samples based on the determination.

A processor for wireless communication is described. The processor may be configured to, capable of, or operable to perform one or more operations as described herein. For example, the processor may comprise at least one memory and at least one controller coupled with the at least one memory and configured to cause the processor to receive, from a network entity, control information indicating a reduced sample size mode of operation associated with data collection performed by the UE, determine whether to apply the reduced sample size mode of operation for a measured set of data, and incorporate the measured set of data into a reduced set of samples based on the determination.

A method performed or performable by the UE is described. The method may comprise receiving, from a network entity, control information indicating a reduced sample size mode of operation associated with data collection performed by the UE, determining whether to apply the reduced sample size mode of operation for a measured set of data, and incorporating the measured set of data into a reduced set of samples based on the determination.

In some implementations of the UE, processor, and method described herein, the UE, processor, and method may further be configured to, capable of, performed, performable, or operable to log the reduced set of samples and/or report the reduced set of samples to the network entity.

In some implementations of the UE, processor, and method described herein, the UE, processor, and method may further be configured to, capable of, performed, performable, or operable to report the logged set of samples to the network entity.

In some implementations of the UE, processor, and method described herein, the control information identifies a procedure to apply to the measured set of data when determining whether to apply the reduced sample size mode of operation.

In some implementations of the UE, processor, and method described herein, the procedure includes determining a similarity condition between the measured set of data and at least one sample from a previously reduced set of data satisfies a threshold similarity metric.

In some implementations of the UE, processor, and method described herein, the procedure includes determining whether one or more conditions associated with measurement of the measured set of data satisfy a threshold.

In some implementations of the UE, processor, and method described herein, the one or more conditions include a quality of measurement of the measured set of data, a buffer size for storing the measurement of the measured set of data, a quantity of measured samples of the measured set of data, or a battery level for the UE.

In some implementations of the UE, processor, and method described herein, the procedure includes sampling batches of the measured set of data, and wherein the control information a number of samples per batch, a time gap between samples of a batch, and a time gap between batches.

In some implementations of the UE, processor, and method described herein, the control information includes downlink control information (DCI).

In some implementations of the UE, processor, and method described herein, the control information indicates what data to measure and what data to log or report to the network entity.

In some implementations of the UE, processor, and method described herein, the control information includes a field that instructs the UE to apply the reduced sample size mode of operation when performing a measurement of the measured set of data.

In some implementations of the UE, processor, and method described herein, the measured set of data includes a set of channel data representations during a first time-frequency-space region.

In some implementations of the UE, processor, and method described herein, the UE, processor, and method may further be configured to, capable of, performed, performable, or operable to report the reduced set of samples to the network entity along with a metric for each sample of the reduced set of samples that represents a weight associated with an importance of the reduced set of samples with respect to other samples of the reduced set of samples.

In some implementations of the UE, processor, and method described herein, the measured set of data is a set of data that is newly measured for a timeslot or a subband.

In some implementations of the UE, processor, and method described herein, the UE, processor, and method may further be configured to, capable of, performed, performable, or operable to report the reduced set of samples to the network entity via a set of resources identified by the control information.

In some implementations of the UE, processor, and method described herein, the set of resources are shared resources for transmitting the reduced set of samples and other uplink data to the network entity.

In some implementations of the UE, processor, and method described herein, the UE, processor, and method may further be configured to, capable of, performed, performable, or operable to report a size or dimensionality of the reduced set of samples to the network entity.

A network entity for wireless communication is described. The network entity may be configured to, capable of, or operable to perform one or more operations as described herein. For example, the network entity may comprise at least one memory and at least one processor coupled with the at least one memory and configured to cause the network entity to transmit, to a UE, control information indicating a reduced sample size mode of operation associated with data collection performed by the UE and receive a set of samples associated with a set of data measured by the UE in accordance with the reduced sample size mode of operation.

A method performed or performable by the network entity is described. The method may comprise transmitting, to a UE, control information indicting a reduced sample size mode of operation associated with data collection performed by the UE and receiving a set of samples associated with a set of data measured by the UE in accordance with the reduced sample size mode of operation.

### BRIEF DESCRIPTION OF THE DRAWINGS

FIG. 1 illustrates an example of a wireless communications system in accordance with aspects of the present disclosure.

FIG. 2 illustrates a signaling diagram between a UE and an NE in accordance with aspects of the present disclosure.

FIG. 3 illustrates another signaling diagram between a UE and an NE in accordance with aspects of the present disclosure.

FIG. 4 illustrates another signaling diagram between a UE and an NE in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

The present disclosure relates to methods, apparatuses, and systems that provide, support, implement, and/or introduce new or enhanced data collection procedures, such as data collection procedures that utilize or are associated with reduced numbers of logged or reported data samples.

The wireless communications system may utilize artificial intelligence/machine learning (AI/ML) modeling to improve the performance of its communications. For example, life cycle management (LCM) may include various stages of AI/ML models for different network services, such as dataset training and/or creation, monitoring, deployment, and so on. Often, the AI/ML models are application or environment specific, where the AI/ML models are trained and/or monitored using data samples collected from the environment to which the models are deployed or otherwise utilized.

As an example, AI/ML models may be used for channel state information (CSI) feedback reporting, where a UE collects CSI and sends communication parameters (e.g., channel quality indicators (CQIs), rank indicators (RIs), precoding matrix indicators (PMIs), and so on), to an NE. The UE may train or tune its AI/ML models based on the CSI and/or data collection environment (e.g., tuning its models to collect PMI for downlink beamforming and interference management enhancements). For certain purposes (e.g., training), the UE may collect and/or log measured data, and then transmit the data to the NE at a later time (e.g., the data collection is not delay sensitive).

Regardless of the data collection purpose, the wireless communications system may seek to balance the collection of a sufficient number of data samples with the overhead that results from the collection procedures. The present disclosure introduces data collection procedures that reduce the number of samples reported to the NE and/or logged by the UE, without introducing degradation in performance and/or accuracy of a trained AI/ML model or a related monitoring scheme.

The UE may receive (e.g., from the NE) control information that indicates a reduced sample size mode of operation associated with data collection, determine whether to apply the reduced sample size mode of operation for a measured set of data, and incorporate the measured set of data into a reduced set of samples based on the determination. For example, the reduced sample size mode of operation may include one or more procedures to apply to the measured set of data, such as procedures that determine how similar a set of data is to previously measured data, procedures based on measurement conditions for the set of data, procedures that determine sampling batches for the set of data, and so on.

Thus, in various examples, the wireless communications system may control or configure a UE to apply a reduced sample size mode of operation when collecting measurement data (e.g., CSI), facilitating the UE to balance the number of samples collected for a certain purpose or service (e.g., training an AI/ML model) with a sufficient level of accuracy or performance, among other benefits.

Aspects of the present disclosure are described in the context of a wireless communications system.

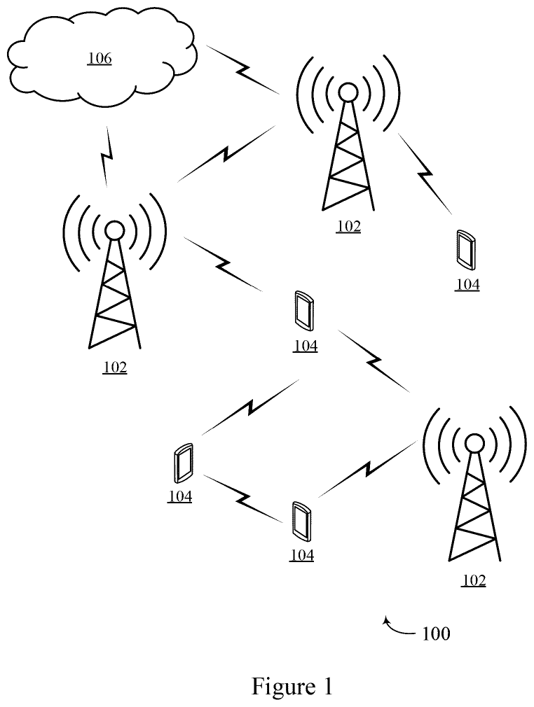

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 or FR2-1 (24.25 GHz-52.6 GHZ), FR3 (7.125 GHZ-24.25 GHZ), FR4 (52.6 GHz-114.25 GHZ), FR4a or FR4-1 or FR2-2 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

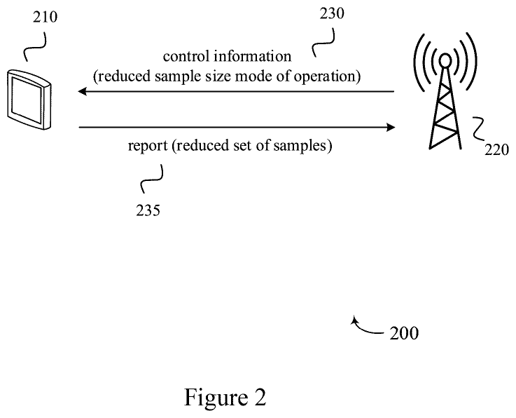

As described herein, the wireless communications system 100 may introduce and/or implement the collection of data (e.g., by the UE 104) using a reduced sample size mode of operation. FIG. 2 illustrates a signaling diagram 200 between a UE 210 and an NE 220 in accordance with aspects of the present disclosure.

The NE 220 transmits control information 230 to the UE 210. The control information 230 may indicate a reduced sample size mode of operation associated with data collection performed by the UE 210. For example, as described herein, the control information 230 may include a configuration or other information that instructs or causes the UE 210 to perform data collection using the reduced sample size mode of operation (e.g., one or more procedures, as described herein).

The UE 210, based on the control information 230, may determine whether to apply the reduced sample size mode of operation for a measured set of data, and incorporate the measured set of data into a reduced set of samples based on the determination. The UE 210 may then log the reduced set of samples and/or transmit a report 235 of the reduced set of samples (e.g., the logged set of samples) to the NE 220.

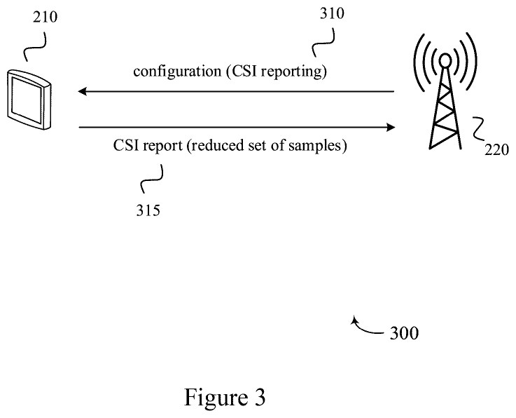

For example, the UE 210 may perform data collection and/or measurement for CSI measurement/reporting. FIG. 3 illustrates another signaling diagram 300 between the UE 210 and the NE 220 in accordance with aspects of the present disclosure. The NE 220 (e.g., a gNB) may transmit a configuration 310 (e.g., for CSI reporting) or otherwise configure the UE 210 to perform CSI measurements using a reduced sample size mode of operation, as described herein. For example, the NE 220, via the configuration 310, may configure the UE 210 to measure one or more CSI reference signal (CSI-RS) resources (e.g., indicated using a CSI-RS-ResourceId parameter) and report or log the measured data (e.g, via CSI-ReportConfig or CSI-LogMeasReport-r19).

In some cases, for CSI reporting, the reportConfigType parameter instructs the UE 210 to utilize a particular type of report, which includes CSI-ReportPeriodicityAndOffset, reportSlotConfig, and reportSlotOffsetList to indicate a periodicity of the report (e.g., whether the report is periodic or semipersistent). The configuration 310 may also include the parameter csi-ReportingBand to indicate to the UE 210 the subband for which data is to be collected.

Thus, for data logging or reporting (e.g., via CSI-logging), the configuration 310 may include a report type, periodicity, and/or offset of a CSI report 315 to be logged or transmitted by the UE 210. The NE 220 may configure the UE 210 (e.g., via the configuration 310) with multiple CSI-reportconfig values, with different parameters, such as different periodicities. The CSI data samples may be in various formats based on the design (e.g., CSI codebook Type-1, 2Type-2, floating points, and so on).

Thus, in some examples, the configuration 310 may be applicable for the collection of CSI data for use with creating and/or training datasets, monitoring data, and so on. For example, for the creation of a training dataset, the NE 220 may configure the UE 210 to perform periodic reporting with a period T₁ (e.g., via CSI-LogMeasReport-r19), causing the UE 210 to store (e.g., log) the training dataset. As another example, with respect to the monitoring of the data collection, the NE 220 may configure the UE 210 with a semipersistent reporting configuration (e.g., a certain period) and activate the configuration when requesting collected monitoring data.

However, for training dataset creation or for collecting samples for model monitoring, the wireless communications system 100 may benefit less from many data samples (e.g., similar to one another) as compared to having the same size samples but with different CSI instances. Instead, for a training dataset of a certain size, the training of an AI/ML model with a dataset having a diverse set of different samples may lead to a better or more useful generalization capability compared with a dataset having numerous similar samples. In some cases, a training set may also consider a popularity of certain sample types. For example, if samples similar to a CSI vector S₁ are more likely as compared to CSI samples close to S₂, the training dataset may show S₁ and S₂ and represent a probability of their accordance (e.g., for use by a loss function that minimizes the average loss function).

While the NE 220 may configure the UE 210 to use aperiodic CSI reporting/logging to collect different samples, the samples may not be sufficiently diverse and/or the NE 220 may perform increased signaling, which can introduce complexity. Thus, as described herein, the NE 220 may signal (e.g., via the configuration 310) to the UE 210 an intention or instruction to collect all data samples and then reduce the number of data samples logged and/or reported (e.g., remove some of the data samples before reporting or logging the data measurements).

For example, the configuration 310 may include a normal CSI-report or a reduced-sample-size CSI-reporting/logging parameter. In some cases, the NE 220 may configure the UE 210 to perform reporting/logging for normal CSI-report, for dataset creation, and/or for monitoring. Thus, the indication of performing reduced-sample-size CSI-reporting/logging may be implicit within other messaging (e.g., whenever the UE 210 is configured for CSI-data reporting, the UE 210 performs in the reduced-sample-size CSI-reporting/logging mode of operation).

In some cases, the UE 210 may transmit a message or otherwise signal to the NE 220 its capabilities for performing the reduced sample size mode of operation when collecting data (e.g., during UE-capability reporting). The UE 210 may include information that indicates its capabilities regarding a type of reduced-sample-size CSI-reporting/logging supported by the UE 210 and/or indicate its support of general data collection support (e.g., used by the NE 220 as a reference capability when configuring the UE 210 for reduced-sample-size CSI reporting/logging).

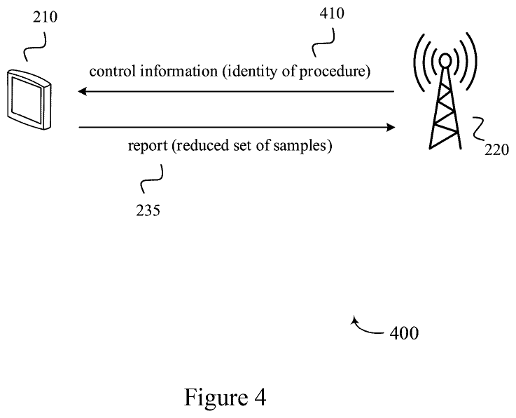

In some examples, the control information 230 and/or the configuration 310 may indicate or identify a procedure to apply to a measured set of data when the UE 210 determines whether to apply the reduced sample size mode of operation. FIG. 4 illustrates another signaling diagram 400 between the UE 210 and the NE 220 in accordance with aspects of the present disclosure.

The NE 220 transmits control information 410 (or other configuration information) to the UE 210. The control information 410 identifies the procedure (or combination of procedures) to be used when determining whether to apply the reduced sample size mode of operation to a set of collected or measured data.

In some cases, the control information 410 identifies a similarity threshold and/or metric for measuring the similarity between data samples. For example, after an initial reporting/logging of a set of data samples, the UE 210, upon measuring a new sample, applies a metric and similarity threshold to determine whether to include the new sample (e.g., a CSI sample) in a reduced set of samples or remove the new sample from logging/reporting.

The UE 210 may apply a metric associated with each use case and/or use a general metric for some or all use cases. For example, the UE 210 may utilize a correlation metric (e.g., eigen vector, cosine similarity, generalized cosine similarity, squared generalized cosine similarity, and so on) to compare data samples. Thus, if there is a high similarity between a new sample and a previously logged sample based on the correlation metric, the UE 210 may determine not to log/report the new sample.

In some cases, the control information 410 identifies other parameters for use in selecting and/or determining data samples for logging/reporting. Such parameters (or conditions) may include a quality of the measured samples (e.g., if CSI is measured in a very noisy condition (e.g., a signal to noise ratio (SNR) is less than a threshold), the UE 210 may determine not to report/log that CSI sample). In some cases, the parameters, conditions, and/or thresholds may be configured by the NE 220 and may be specific to certain logging/reporting configurations and/or use cases.

The parameters or conditions may also include certain characteristics of the UE 210, such as a storage level available to the UE 210 for logging data samples. Thus, the UE 210 may report/log all data samples until its available storage falls below a threshold capacity (e.g., 25 percent), at which time the UE 210 may reduce the number of reported or logged data samples, as described herein. In some cases, the NE 220 may signal the UE 210 to perform the reduced sample size mode of operation when an available buffer for the UE 210 meets or is lower than a buffer threshold.

In some cases, each data sample may be associated with a number or ratio, with respect to other data samples of a certain measurement or collection operation (e.g., a CSI reporting operation). The number or ratio may be associated with the data samples as metadata, indicating how often that data sample has been observed with respect to the other data samples of the operation. For example, a logged CSI vector 11 is associated with number k₁ and logged CSI vector ν₂ is associated with number k₂, where k₁/k₂ represents the ratio between how often the measured CSI samples correspond to ν₁ relative to ν₂.

In some cases, such as for training dataset creation operations), the UE 210 may compare a new data sample (or most recently measured data sample) to all other collected (or logged) data samples of an operation and/or to a certain number of logged data samples (based on timing information). The UE 210 may determine a similarity between the new data sample and the set of data samples when determining whether to log the new data sample (or drop the data sample from the logged data).

In some examples, such as with respect to CSI compression, different CSI samples may refer to different CSIs measured at different time slots and/or different CSIs measured for different subbands (e.g., for subband reporting) configured by pmi-FormatIndicator. For subband reporting, the UE 210 may report/log a subbands report for each of the subbands indicated by csi-ReportingBand. However, when the UE 210 is configured with the reduced-sample-size CSI-reporting configuration, the UE 210 may only report/log the data samples based on criteria set by the NE 220. In some cases, during the reduced-sample size mode of operation, the UE 210 may not transmit certain data or metadata associated with the data samples (e.g., time stamp, Cell-ID, and so on).

The UE 210 may determine to report/log a measured data sample, where the number of data samples to be reported/logged is not fixed for each time period. While not an issue when logging the data samples, the UE 210, when reporting data samples (e.g., for monitoring purposes) is to use uplink resources assigned to the UE 210 by the NE 220. Thus, if the NE 220 pre-assigns fixed uplink resources for reporting, but the UE 210 determines (as described herein) not to send a current or newly measured data sample (e.g., for monitoring information), these uplink resources may be unused and thus unavailable for other purposes or uses.

To avoid the loss of uplink resources, the UE 210 may be configured to utilize the same uplink resources (e.g., physical uplink shared channel (PUSCH) resource blocks (RBs) for reporting monitoring data and performing other uplink data transmissions. Thus, the PUSCH RBs may be shared. For example, when there is minimal monitoring data (e.g., fewer, or few data samples), the UE 210 may transmit more data from a transport block (TB) (e.g., with less puncturing rate). However, when the UE 210 determine to send more data samples for monitoring (although less than the number of resources allocated for monitoring reporting), the UE 210 may send fewer symbols from the transport block (e.g., with more puncturing).

In some cases, the whole TB size may be determined based on the UE 210 reporting all measured data samples for all time slots and for all subbands, and when the UE 210 determines not to send some of the data samples, the UE 210 may apply less puncturing when populating resource elements (REs) with TB information. The UE 210 may determine the TB size based on the expected size of the reporting (e.g., based on reporting in previous time slots).

In some cases, when a dynamic resource size is used for reporting the monitoring data, the UE 210 may transmit information identifying the number of data samples transmitted in the uplink (e.g., PUSCH) resource for monitoring. The NE 220, using the number, may determine the REs used for the monitoring report and the REs used for other data transmissions. The UE 210 may perform the monitoring based on a network configuration and report a number of data samples that match the number of uplink resources configured by the NE 220. When the number of available data samples is less than the assigned uplink resources, the UE 210 may apply padding to the surplus or unused resources.

In some examples, the control information 410 may configure the UE 210 to report/log data samples with different gaps between data samples (e.g., to create batches of data samples). For example, the NE 220 may configure the UE 210 to first report/log N₁ samples, which are separated by T₁ time slots, to then report/log the next sample after T₂ time slots, and then report/log the N₁ samples separated by T₁. Thus, the reported/logged samples become a batch of N₁ samples, where the data samples within each batch are separated by T₁ time slots and different batches are separated by T₂ time slots.

In some cases, the UE 210 may perform measurements at a frequency that is greater than the reporting/logging intervals, and measurements (e.g., for calculating the monitoring report) and/or transmission of reference signal (RS) resources used for monitoring may be set as batches with similar time gaps used for reporting/logging. In such cases, the NE 220, via the control information 410, may transmit two parameters associated with T₁and T₂, and one number N₁, showing how many data samples are contained in each batch of the measured and logged/reported data samples. The NE 220 may increase the number of batches, such as by adjusting the time gaps and/or number of data samples. In In some cases, such configurations may be extensions of periodic or semipersistent reporting types (e.g., introducing new parameters, such as CSI-ReportBatchGap and CSI-nrofReportedRSinBatch).

In doing so, the NE 220 may enable collected data to preserve statistics about the data samples close to each other (in each batch) while also increasing sample diversity when measuring different batches apart from one another. Further, for AI/ML model monitoring, the data samples within each batch may enable the monitoring to determine the model performance for the current measurement and the data samples in different batches may be used to determine the overall performance of the model.

While the disclosed technology has been described with respect to CSI reporting, the UE 210 may implement the reduced sample size mode of operation for other data type or data collection operations. Further, for some applications (such as monitoring), the reported data samples may include parameters that are derived based on the measured data or statistics associated with the measured data.

In some examples, the collection of data may be performed by the network (e.g., the NE 220, such as a gNB), and thus the NE 220 may perform the reduced sample size mode of operation when logging and/or reporting data samples. Thus, a first node may be configured by a second node (e.g., via control information 230 and/or 410) to perform the reduced sample size mode of operations described herein, where the first node is the UE 210 or the NE 220.

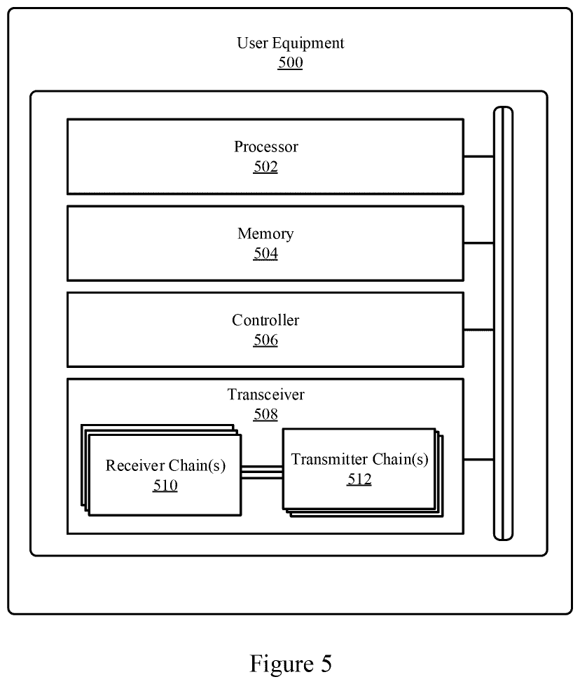

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for receiving, from a network entity, control information indicating a reduced sample size mode of operation associated with data collection performed by the UE, determining whether to apply the reduced sample size mode of operation for a measured set of data, and incorporating the measured set of data into a set of reduced samples based on the determination.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

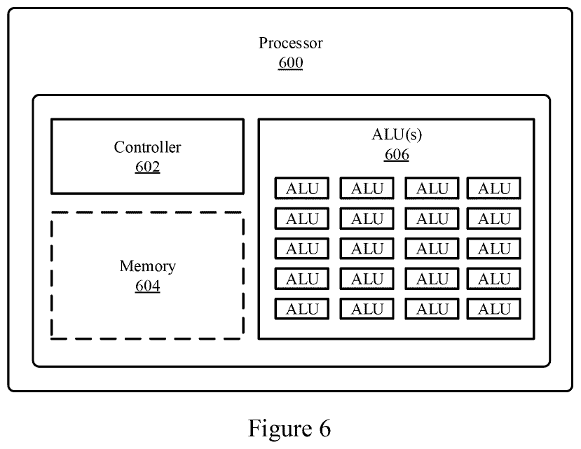

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for receiving, from a network entity, control information indicating a reduced sample size mode of operation associated with data collection performed by the UE, determining whether to apply the reduced sample size mode of operation for a measured set of data, and incorporating the measured set of data into a set of reduced samples based on the determination.

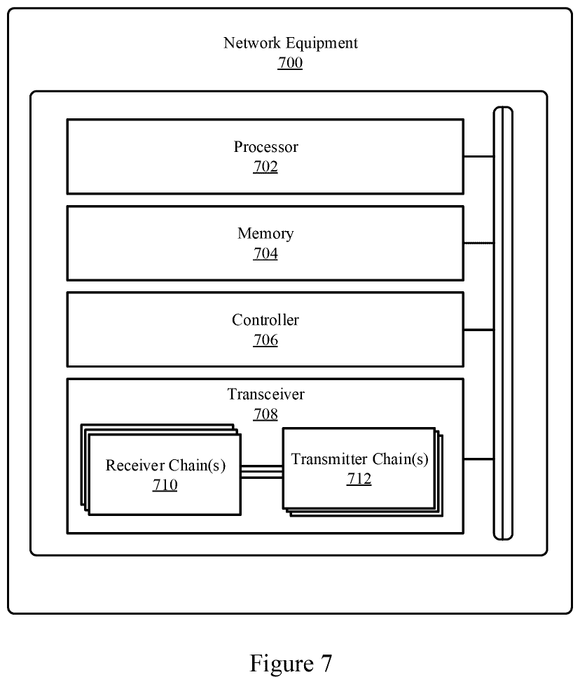

FIG. 7 illustrates an example of a NE 700 in accordance with aspects of the present disclosure. The NE 700 may include a processor 702, a memory 704, a controller 806, and a transceiver 708. The processor 702, the memory 704, the controller 806, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 806, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to support a means for transmitting, to a UE, control information indicating a reduced sample size mode of operation associated with data collection performed by the UE and receiving a set of samples associated with a set of data measured by the UE in accordance with the reduced sample size mode of operation.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

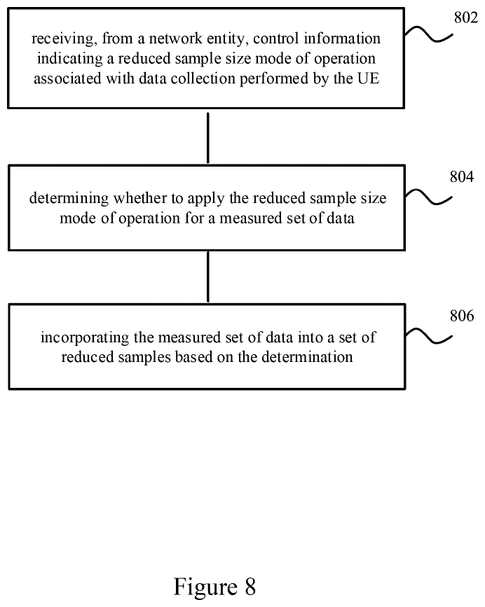

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include receiving, from a network entity, control information indicating a reduced sample size mode of operation associated with data collection performed by the UE. The operations of 802 may be performed in accordance with examples as described herein. In some implementations, aspects of the operations of 802 may be performed by a UE as described with reference to FIG. 5.

At 804, the method may include determining whether to apply the reduced sample size mode of operation for a measured set of data. The operations of 804 may be performed in accordance with examples as described herein. In some implementations, aspects of the operations of 804 may be performed a UE as described with reference to FIG. 5.

At 806, the method may include incorporating the measured set of data into a set of reduced samples based on the determination. The operations of 806 may be performed in accordance with examples as described herein. In some implementations, aspects of the operations of 806 may be performed a UE as described with reference to FIG. 5.

It should be noted that the method described herein describes a possible implementation, and that the operations and the steps may be rearranged or otherwise modified and that other implementations are possible.

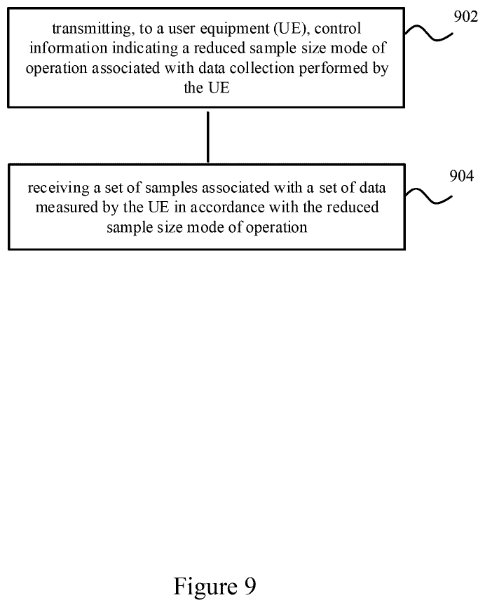

FIG. 9 illustrates a flowchart of a method in accordance with aspects of the present disclosure. The operations of the method may be implemented by an NE as described herein. In some implementations, the NE may execute a set of instructions to control the function elements of the NE to perform the described functions.

At 902, the method may include transmitting, to a UE, control information indicating a reduced sample size mode of operation associated with data collection performed by the UE. The operations of 902 may be performed in accordance with examples as described herein. In some implementations, aspects of the operations of 902 may be performed by an NE as described with reference to FIG. 7.

At 904, the method may include receiving a set of samples associated with a set of data measured by the UE in accordance with the reduced sample size mode of operation. . . . The operations of 904 may be performed in accordance with examples as described herein. In some implementations, aspects of the operations of 904 may be performed by an NE as described with reference to FIG. 7.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network entity, control information indicating a reduced sample size mode of operation associated with data collection performed by the UE;
determine whether to apply the reduced sample size mode of operation to a measured set of data; and
incorporate the measured set of data into a reduced set of samples based on the determination.

2. The UE of claim 1, wherein the at least one processor is further configured to cause the UE to:
log the reduced set of samples; or
report the reduced set of samples to the network entity.

3. The UE of claim 2, wherein the at least one processor is further configured to cause the UE to:
report the logged set of samples to the network entity.

4. The UE of claim 1, wherein the control information identifies a procedure to apply to the measured set of data when determining whether to apply the reduced sample size mode of operation.

5. The UE of claim 4, wherein the procedure includes determining a similarity condition between the measured set of data and at least one sample from a previously reduced set of data satisfies a threshold similarity metric.

6. The UE of claim 4, wherein the procedure includes determining whether one or more conditions associated with measurement of the measured set of data satisfy a threshold.

7. The UE of claim 6, wherein the one or more conditions include a quality of measurement of the measured set of data, a buffer size for storing the measurement of the measured set of data, a quantity of measured samples of the measured set of data, or a battery level for the UE.

8. The UE of claim 4, wherein the procedure includes sampling batches of the measured set of data, and wherein the control information a number of samples per batch, a time gap between samples of a batch, and a time gap between batches.

9. The UE of claim 1, wherein the control information includes downlink control information (DCI).

10. The UE of claim 1, wherein the control information indicates what data to measure and what data to log or report to the network entity.

11. The UE of claim 1, wherein the control information includes a field that instructs the UE to apply the reduced sample size mode of operation when performing a measurement of the measured set of data.

12. The UE of claim 1, wherein the measured set of data includes a set of channel data representations during a first time-frequency-space region.

13. The UE of claim 1, wherein the at least one processor is further configured to cause the UE to:
report the reduced set of samples to the network entity along with a metric for each sample of the reduced set of samples that represents a weight associated with an importance of the reduced set of samples with respect to other samples of the reduced set of samples.

14. The UE of claim 1, wherein the measured set of data is a set of data that is newly measured for a timeslot or a subband.

15. The UE of claim 1, wherein the at least one processor is further configured to cause the UE to:
report the reduced set of samples to the network entity via a set of resources identified by the control information.

16. The UE of claim 15, wherein the set of resources are shared resources for transmitting the reduced set of samples and other uplink data to the network entity.

17. The UE of claim 16, wherein the at least one processor is further configured to cause the UE to:
report a size or dimensionality of the reduced set of samples to the network entity.

18. A network entity for wireless communication, comprising:
at least one memory; and
at least one processor coupled with the at least one memory and configured to cause the network entity to:
transmit, to a user equipment (UE), control information indicating a reduced sample size mode of operation associated with data collection performed by the UE; and
receive a set of samples associated with a set of data measured by the UE in accordance with the reduced sample size mode of operation.

19. A method performed by a user equipment (UE), the method comprising:
receiving, from a network entity, control information indicating a reduced sample size mode of operation associated with data collection performed by the UE;
determining whether to apply the reduced sample size mode of operation for a measured set of data; and
incorporating the measured set of data into a set of reduced samples based on the determination.

20. A method performed by a network entity, the method comprising:
transmitting, to a user equipment (UE), control information indicating a reduced sample size mode of operation associated with data collection performed by the UE; and
receiving a set of samples associated with a set of data measured by the UE in accordance with the reduced sample size mode of operation.
